(19) United States
(12) Patent Application Publication
(10) Pub. No.: US 2026/0167536 A1
(43) Pub. Date: Jun. 18, 2026

(54) GAS INFUSION MODULE SYSTEMS

(71) Applicant: Prosper Technologies, LLC, Miami Beach, FL (US)

(72) Inventor: David Wade Campbell, Fredericton N.B. (CA)

(21) Appl. No.: 19/126,196

(22) PCT Filed: Oct. 31, 2023
(86) PCT No.: PCT/US2023/036512

§ 371 Date: Apr. 30, 2025

Related U.S. Application Data
(60) Provisional application No. 63/382,467, filed on Nov. 4, 2022.

(51) Int. Cl. C02F 1/72

(52) U.S. Cl. CPC C02F 1/72; C02F 2201/004; C02F 2201/007

(57) ABSTRACT

A gas infusion module system includes a first pipe having an inlet for receiving a source of fluid. The system also includes an array of modules positioned downstream of the inlet. The array of modules includes an inlet in fluid connection with a source of gas and a gas infusion module comprising a plurality of fibers. The gas infusion module is disposed at least partially inside the array of modules. The system also includes a second pipe having an outlet, the second pipe positioned downstream of the array of modules. The fluid, such as wastewater, flows through the array of modules and exits the system via the outlet of the second pipe.

### INCORPORATION BY REFERENCE TO ANY PRIORITY APPLICATIONS

This application claims priority to U.S. Provisional Patent Application No. 63/382467, filed Nov. 4, 2022, which is hereby incorporated by reference in its entirety.

### BACKGROUND OF THE INVENTION

### Field of the Invention

The invention is directed to a gas infusion module system, and more particularly to a gas infusion module system for treatment of a liquid stream.

### Description of the Related Art

Existing liquid stream treatment systems are complex and inefficient. There is a need for more efficient and cost-effective gas infusion module systems.

### SUMMARY OF THE INVENTION

In accordance with one aspect of the disclosure, a gas infusion module system is provided, and more particularly a gas infusion module system for treatment of a liquid stream.

According to some embodiments, a gas infusion module system can include a first pipe having an inlet for receiving a fluid from a source of fluid; and an array of modules positioned downstream of and in fluid communication with the first pipe. The array of modules can include an inlet in fluid connection with a source of gas. The gas infusion module system can include a gas infusion module including a plurality of fibers. The gas infusion module can be disposed at least partially inside the array of modules. The gas infusion module system can include a second pipe having an outlet, the second pipe positioned downstream of and in fluid communication with the array of modules. The fluid can flow through the array of modules and exit the system via the outlet.

A variation of the aspect above, wherein the gas infusion module system includes a first plurality of distribution lines in fluid connection with the first pipe and the array of modules; and a second plurality of distribution lines in fluid connection with the second pipe and the array of modules.

A variation of the aspect above, wherein the gas inlet includes a first gas inlet and a second gas inlet, and wherein the gas infusion module includes a first gas infusion module positioned at the first gas inlet and a second gas infusion module positioned at the second gas inlet.

A variation of the aspect above, wherein the array of modules includes 120 modules.

A variation of the aspect above, wherein the array of modules is arranged in two ten-by-six arrays.

A variation of the aspect above, wherein the array of modules includes 260 modules.

A variation of the aspect above, wherein the array of modules is arranged in two ten-by-thirteen arrays.

A variation of the aspect above, wherein the array of modules includes a first adapter and a second adapter, the first and second adapters configured to secure a first module of the array of modules to at least a second module of the array of modules.

A variation of the aspect above, wherein the first adapter is positioned on a first end of the array of modules and the second adapter is positioned on a second end of the array of modules.

A variation of the aspect above, wherein the gas infusion module system includes at least one rod removably attached to at least one of the first and second adapters; and at least one O-ring positioned between at least one of a pair of first adapters and a pair of second adapters. The rod can be configured to adjust a distance between the at least the one pair of first adapters and the pair of second adapters. The at least one O-ring creates a seal between the at least the one pair of first adapters and the pair of second adapters.

According to some embodiments, a gas infusion module system can include a first pipe having an inlet for receiving a fluid from a source of fluid; and an array of modules positioned downstream of and in fluid communication with the first pipe. The array of modules can include a gas infusion module including a plurality of fibers. The gas infusion module disposed at least partially inside the array of modules. The gas infusion module system can include a second pipe having an outlet, the second pipe positioned downstream of and in fluid communication with the array of modules. The array of modules can be in fluid communication with a source of gas via a gas tubing. The fluid can flow through the array of modules and exit the system via the outlet.

A variation of the aspect above, wherein the gas infusion module system can include a first plurality of connectors, each connector of the first plurality of connectors in fluid communication with the first pipe and at least two modules of the array of modules.

A variation of the aspect above, wherein the gas infusion module system can include a second plurality of connectors, each connector of the second plurality of connectors in fluid communication with the second pipe and at least two modules of the array of modules.

A variation of the aspect above, wherein the inlet and the outlet are positioned on a first side of the of the gas infusion module system.

A variation of the aspect above, wherein the array of modules includes 50 modules.

A variation of the aspect above, wherein the array of modules is arranged in a twenty-five-by-two array.

According to some embodiments, a gas infusion module system can include a first pipe having an inlet for receiving a fluid from a source of fluid; a first distribution line positioned downstream of and in fluid communication with the first pipe; a plurality of headers positioned downstream of and in fluid communication with the first distribution line; and an array of modules positioned downstream of and in fluid communication with the plurality of headers. The array of modules can include a gas infusion module including a plurality of fibers, the gas infusion module disposed at least partially inside the array of modules. The gas infusion module system cab include a plurality of footers positioned downstream of and in fluid communication with the array of modules; a second distribution line positioned downstream of and in fluid communication with the first pipe; a second pipe having an outlet, the second pipe positioned downstream of and in fluid communication with the second distribution line. The array of modules is in fluid communication with a source of gas. The fluid can flow through the array of modules and exit the system via the outlet.

A variation of the aspect above, wherein the gas infusion module system includes a first plurality of connectors, each connector of the first plurality of connectors in fluid communication with the plurality of headers and at least two modules of the array of modules.

A variation of the aspect above, wherein the gas infusion module system includes a second plurality of connectors, each connector of the second plurality of connectors in fluid communication with the plurality of footers and at least two modules of the array of modules.

A variation of the aspect above, wherein the inlet and the outlet are positioned on opposite sides of the gas infusion module system.

A variation of the aspect above, wherein the array of modules includes 250 modules.

A variation of the aspect above, wherein the array of modules is arranged in a twenty-five-by-eight array.

A variation of the aspect above, wherein the plurality of headers includes four headers.

A variation of the aspect above, wherein the plurality of footers includes four footers.

### BRIEF DESCRIPTION OF THE DRAWINGS

FIG. 1A shows a cross section view of an example gas infusion array including at least one gas infusion module.

FIGS. 1B-1D show an example of a gas infusion module and parts thereof.

FIGS. 2A-2D show another example of an embodiment of a gas infusion module system.

FIG. 2E shows an example of a module for a gas infusion module system.

FIG. 2F shows a cross section view of the module shown in FIG. 2E.

FIGS. 3A and 3B show another example of a module array and module, respectively, for use in gas infusion module system.

FIG. 3C shows a cross section view of the module shown in FIG. 3B.

FIG. 4A shows another example of a module for use in gas infusion module system.

FIG. 4B shows an exploded view of the module shown in FIG. 4A.

FIG. 4C shows a portion of a gas infusion module for use in a gas infusion module system.

FIG. 5A shows another example of an embodiment of a gas infusion module system.

FIGS. 5B-5E show an example of a module array or module for use in a gas infusion module system.

FIG. 6 shows another example of an embodiment of a gas infusion module system.

FIG. 7A shows another example of an embodiment of a gas infusion module system.

FIG. 7B shows a top view of the gas infusion module system shown in FIG. 7A.

FIG. 7C shows a side view of the gas infusion module system shown in FIG. 7A.

FIG. 7D shows a front view of the gas infusion module system shown in FIG. 7A.

### DETAILED DESCRIPTION

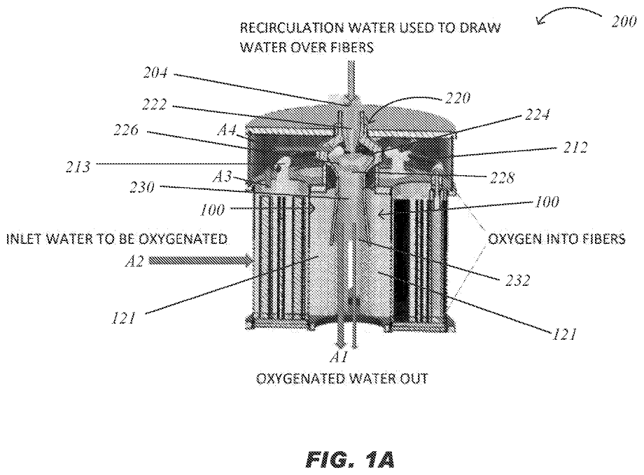

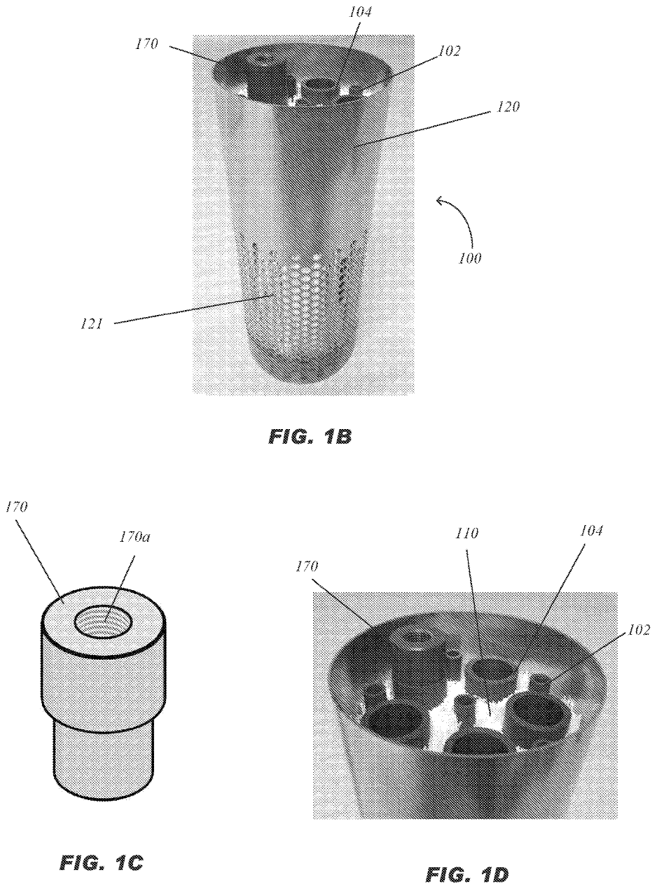

FIG. 1A shows a cross section view of an example gas infusion array including at least one gas infusion module.

Two or more gas infusion modules, such as infusion module 100 from U.S. Provisional Application No. 63/382445, filed on Nov. 4, 2022, and which is incorporated herein by reference in its entirety, can be used in a gas infusion array 200, as shown in FIG. 1A. The gas infusion array 200 can be in fluid communication with a source of liquid stream. The gas infusion array 200 can include an opening 204 via which the liquid stream can enter the gas infusion array 200. Oxygen is fed to the gas infusion array 200 via a gas transfer system connected to a source of oxygen (e.g., an oxygen generator or oxygen tank) for delivering oxygen to the gas infusion array 200. The gas infusion array 200 can include one or more gas infusion modules 100. In some cases, the gas infusion array 200 can include six infusion modules 100 (e.g., arranged in parallel). In the illustrated implementation, the gas infusion modules 100 are arranged circumferentially about an axis of the array 200. The fluid stream can enter the gas infusion array 200 via the opening 204 and flow from a top portion of gas infusion array 200 to a bottom portion of the gas infusion array 200 and exit the gas infusion tank via a tube and opening located on a bottom portion of the gas infusion array 200. As the fluid stream flows through the plurality of gas infusion modules 100, oxygen can be transferred to the fluid stream (e.g., replacing other gases) and can dissolve into the fluid stream. A hose 212 can facilitate distribution of the gas to each infusion module 100 via a fitting 213 which can be removably attached to the connection port 170 of the infusion modules 100. The hose 212 can extend circumferentially around an axis of the array 200 and be in fluid connection with each gas infusion module 100 of the array 200. Beneficially, the plurality of perforations 121 allow the fluid stream to be in direct contact with the fibers 110. This process allows the fluid stream to achieve super-saturated oxygen levels, without the formation of gas bubbles, thereby inhibiting (e.g., preventing) loss of oxygen via bubbles that pass through the fluid stream. Beneficially, the more efficient oxygen transfer of the gas infusion array 200 can reduce energy consumption as compared with other existing gas infusion systems (e.g., using air blowers).

The gas infusion array 200 can include an eductor 220 which can facilitate flowing of the liquid through the array 200. The eductor 220 can include a nozzle 222, an inlet 224, a converging nozzle 226, a diffuser throat 228, a diverging diffuser 230, and an outlet 232. The nozzle 222 can be in fluid connection with the opening 204. In some cases, the diffuser throat 228 has an average cross section diameter larger than a cross section diameter of the converging nozzle 226 and the diverging diffuser 230. After entering the gas infusion array 200 via the opening 204, the liquid can flow through the nozzle 222, the converging nozzle 226, the diffuser throat 228, the diverging diffuser 230, and exit the eductor 220 via the outlet 232. Upon exiting the eductor 220, the fluid can flow towards the bottom of the array 200, as shown by arrow A1. The fluid can flow sideways into the modules 100 via the plurality of perforations 121, as shown by arrow A2. The fluid can flow among the fibers 110 of the infusion modules 100 from a first end on the bottom of the array 200 towards a top portion of the modules 100, as shown by arrow A3. The fluid can renter the eductor 220 via the inlet 224, as shown by arrow A4. The eductor 220 can pump the liquid though the array 200. For example, the eductor 220 can generate a vacuum that draws the liquid from the bottom portion of the array 200 and though the infusion modules 100. The vacuum generated by the eductor 220 can also suck at least a portion of the liquid flowing from the bottom portion to the top portion of the array 200 into the eductor 220 via the inlet 224. Beneficially, the eductor 220 provides pumping which allows the fluid to circulate through the array 200 and does not need moving parts, reduces liquid waste, and increases the efficiency (e.g., reduces losses) of the array 200.

In some cases, the gas infusion array 200 can be housed inside a tank, such as tank 1600 from International Application No. PCT/US2022/027434, filed on May 6, 2021, and which is incorporated herein by reference in its entirety. For example, the tank 1600 can include one or more gas infusion arrays 200. The gas infusion arrays 200 can be positioned in series and at one or more chambers of the tank 1600.

FIG. 1B shows an example of a gas infusion module 100 with a connection port 170 attached to a core 104, FIG. 1C shows the connection port 170 and FIG. 1D shows a top end of the gas infusion module 100 in FIG. 1B. In some cases, the connection port 170 can include a thread 170a along an interior portion of the connection port 170. The thread 170a can facilitate connection of the connection port 170 to a source of gas (e.g., oxygen) via the hose 212 and the fitting 213. The connection port 170 can be attached to a core 104 including a drilled hole on a bottom portion. Beneficially, this can allow the gas to flow the entire length of the core 104 thereby oxygenating the fibers 110 of the module 100. For example, the gas can be injected to the infusion module 100 via the connection port 170 and flow down the entire length of the core 104 the connection port 170 is attached to. The gas can exit the core 104 via the drilled hole and then flow through the gap between the seals of the module 100 and continue to flow upward through the open ends of the fibers 110.

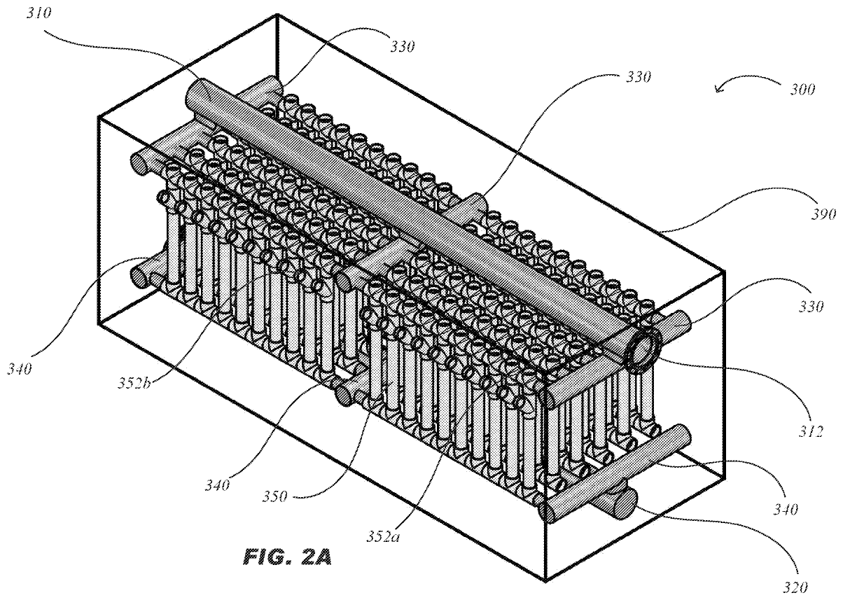

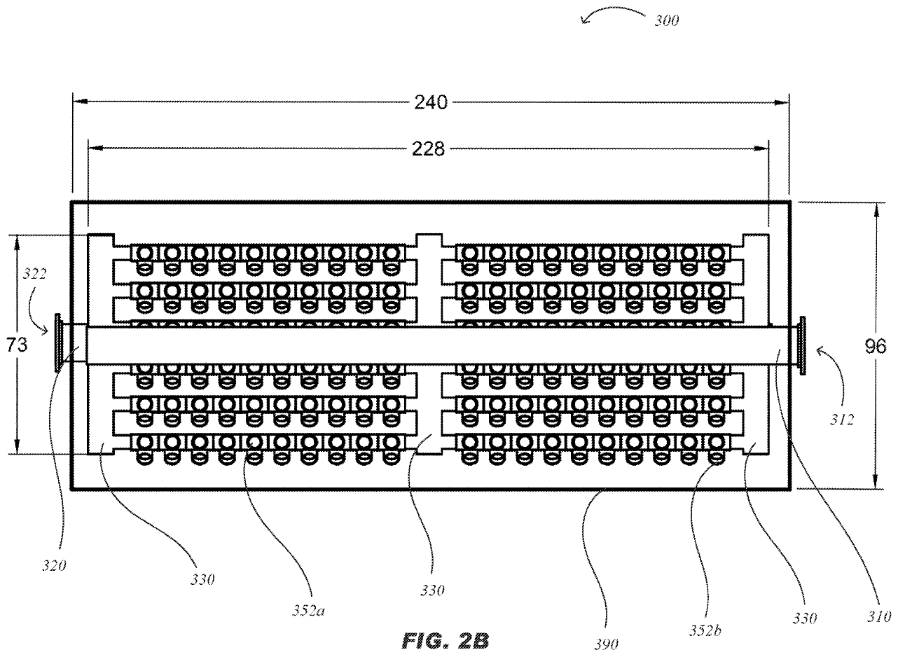

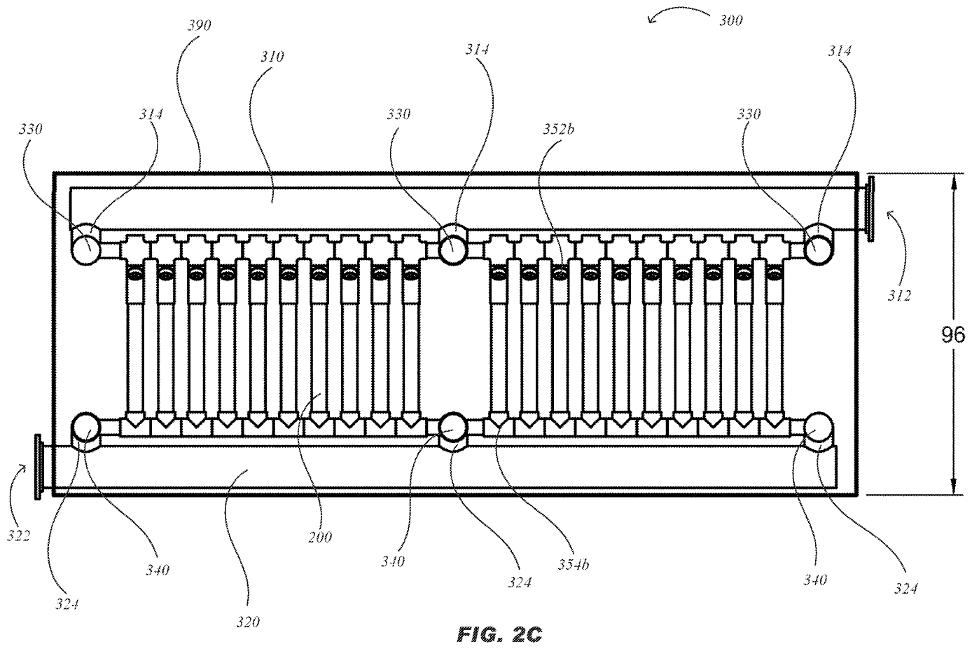

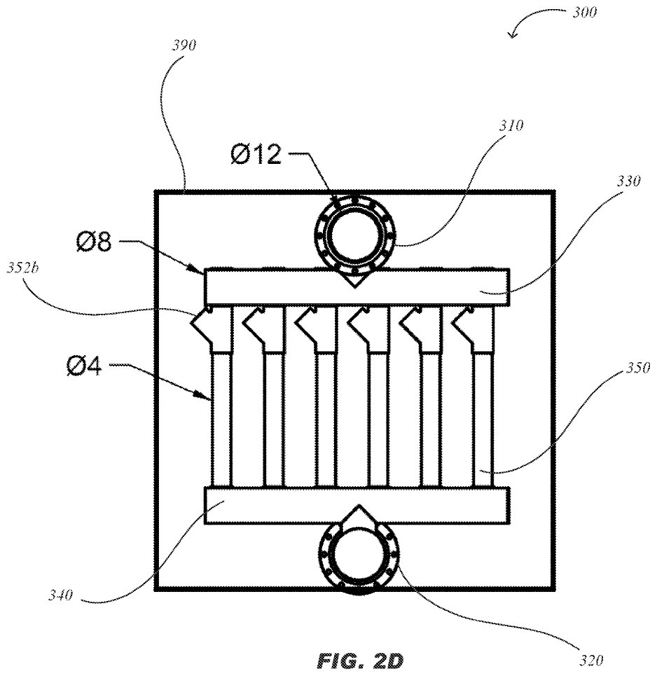

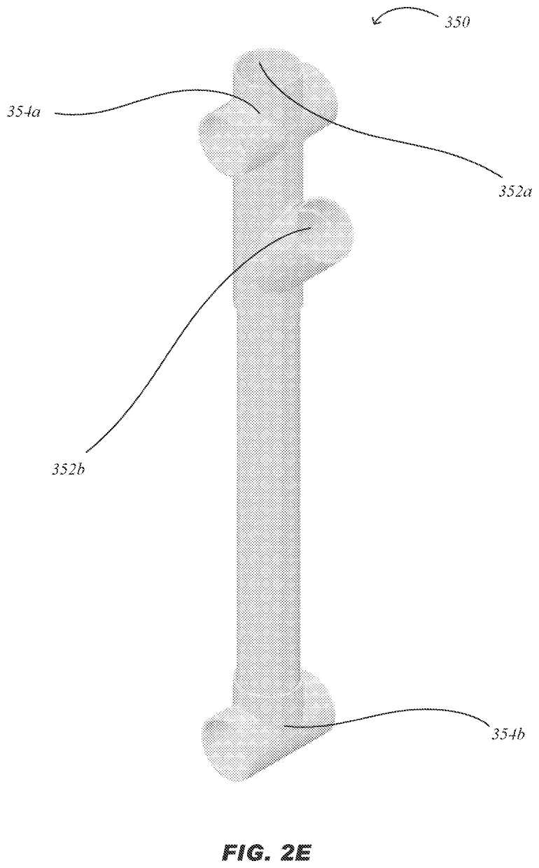

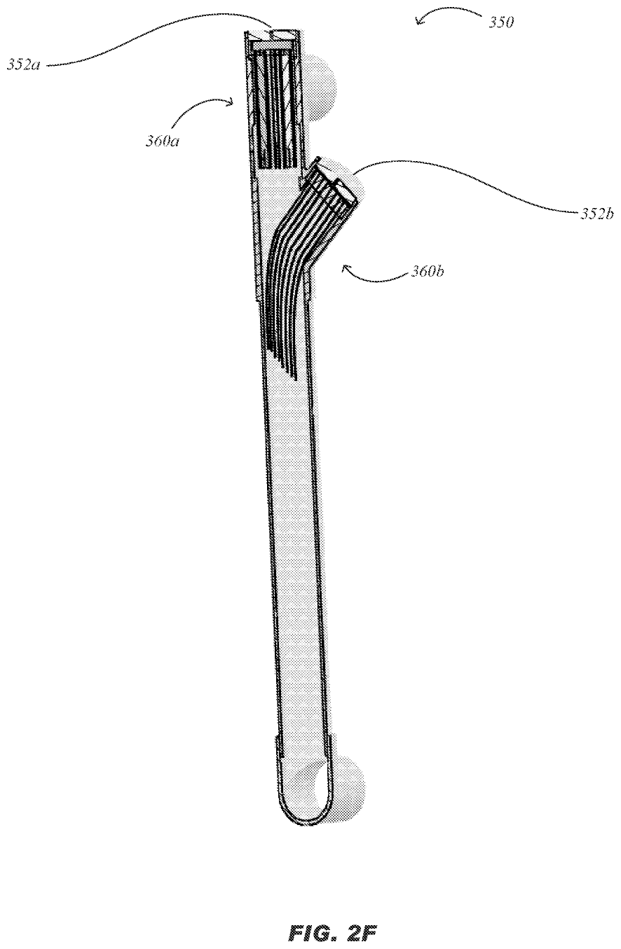

FIGS. 2A-2D show another embodiment of a gas infusion module system 300. The gas infusion module system 300 can include a first pipe 310, a second pipe 320, a first plurality of distribution lines 330, a second plurality of distribution lines 340, and one or more (e.g., an array of) modules 350 (e.g., arranged linearly, in parallel, in multiple rows). The gas infusion module system 300 can be arranged inside a container 390. In some cases, the container 390 measures about 96 in (in width and height) by about 240 in (in length). The container 390 can include one or more openings through which the first and second pipes 310, 320 can at least partially extend. The first pipe 310 and associated distribution lines 330 can form a header and the second pipe 320 and plurality of distribution lines 340 can form a second header. In some cases, the first and second distribution lines 330, 340 can measure about 73 in by about 228 in. The gas infusion module system 300 can be in fluid communication with a source of liquid. For example, liquid can enter the gas infusion module system 300 via an inlet 312 of the first pipe 310. The fluid can flow through the system 300 via the first pipe 310, the first plurality of distribution lines 330, the modules 350, the second plurality of distribution lines 340, and exit the system via an outlet 322 of the second pipe 320. The first plurality of distribution lines 330 can be in fluid communication with the first pipe 310 via one or more adapters or connections 314, and the second plurality of distribution lines 340 can be in fluid communication with the second pipe 320 via one or more adapters or connections-324. In some cases, the modules 350 can have a diameter of or about 4 in, the first and second plurality of distribution lines can have a diameter of or about 8 in, and the first and second pipes 310, 320 can have a diameter of or about 12 in.

FIG. 2E shows an example of a module 350. Each of the modules 350 can include one or more inlets 352a, 352b, one or both of which can be in fluid communication with a source of gas (e.g., oxygen). The modules 350 can also include an upper adapter or connection 354a and a lower adapter or connection 354b. The inlet 352b is at an angle relative to the inlet 352a and between the upper adapter 354a and the lower adapter 354b. The upper and lower adapters or connections 354a, 354b can facilitate attachment of the modules 350 to each other and/or to the first and second plurality of distribution lines 330, 340. For example, the upper adapter 354a of a first module 350 can be connected to the first plurality of distribution lines 330 on one end and to a second upper adapter 354a of a second module 350 on the other end. The upper adapter 354a can also be connected to a pair of upper adapters 354a (of adjacent modules 350) on both ends. The connection between the upper adapters 354a and the first plurality of distribution lines 330 can allow the liquid-entering the system 300 via the inlet 312 to flow though the modules 350. The lower adapter 354b of a first module 350 can be connected to the second plurality of distribution lines 340 on one end and to a second lower adapter 354a of a second module 350 on the other end. The lower adapter 354b can also be connected to a pair of lower adapters 354a (of adjacent modules 350) on both ends. The connection between the lower adapters 354b and the second plurality of distribution lines 340 can allow the liquid flowing entering the system 300 to flow through the modules 350 and the second plurality of distribution lines 340, and exit the system 300 via the outlet 322 of the second pipe 320. Although reference is made to oxygen as an example of a gas that be used with the systems disclosed herein, one of skill in the art will understand that any gas, including but not limited to nitrogen, can be used with the systems disclosed herein to infuse a liquid with such gas.

FIG. 2F shows a cross section view of a module 350. Each of the modules 350 can include one or more gas infusion modules, such as gas infusion module 100, at or near the inlet 352a, 352b. For example, a first gas infusion module 360a can be positioned at or near the first inlet 352a and a second gas infusion module 360b can be positioned at or near the inlet 352a. The gas injected into the system 300 via the inlets 352a, 352b of the modules 350 can be infused into the fibers of the gas infusion modules 360a, 360b. For example, after entering the modules 350, the gas can flow through the modules 350 and the fibers of the gas infusion modules 360a, 360b and infuse the liquid flowing through the module 350 (e.g., between the first plurality of distribution lines 330 and the second plurality of distribution lines 340).

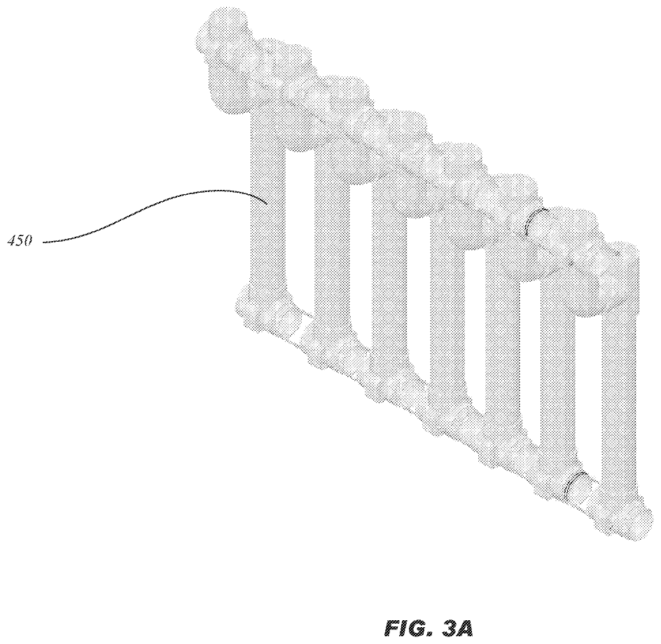

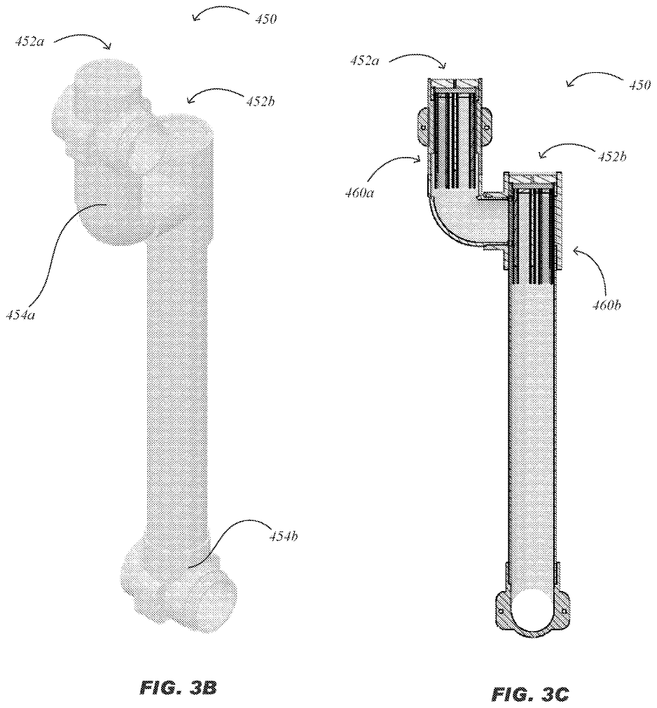

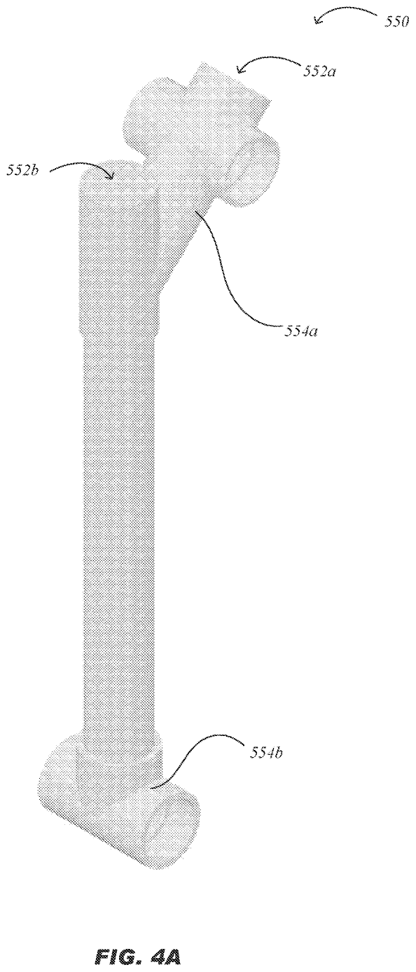

FIG. 3A shows another example of an array of modules 450 (e.g., arranged linearly, in parallel) which can be used in gas infusion module system 300, and FIG. 3B shows an individual module 450. Each of the modules 450 can include one or more inlets 452a, 452b, which can be in fluid connection with a source of gas (e.g., oxygen). The modules 450 can also include an upper adapter or connection 454a and a lower adapter or connection 454b. The inlet 452b has the same orientation as the inlet 452a but disposed lower than the inlet 452a, with the upper adapter 454a between the inlets 452a, 452b. The upper and lower adapters 454a, 454b can facilitate attachment of the modules 450 to each other and/or to the first and second plurality of distribution lines 330, 340 of the system 300. For example, the upper adapter 454a of a first module 450 can be connected to the first plurality of distribution lines 330 on one end and to a second upper adapter 454a of a second module 450 on the other end. The upper adapter 454a can also be connected to a pair of upper adapters 454a (e.g., of adjacent modules 450) on both ends. The connection between the upper adapters 454a and the first plurality of distribution lines 330 can allow the liquid entering the system 300 via the inlet 312 to flow though the modules 450. The lower adapter 454b of a first module 450 can be connected to the second plurality of distribution lines 340 on one end and to a second lower adapter 454b of a second module 450 on the other end. The lower adapter 454b can also be connected to a pair of lower adapters 454b (e.g., of adjacent modules 450) on both ends. The connection between the lower adapters 454b and the second plurality of distribution lines 340 can allow the liquid flowing entering the system 300 to flow through the modules 450 and the second plurality of distribution lines 340, and exit the system 300 via the outlet 322 of the second pipe 320.

FIG. 3C shows a cross section view of a module 450. Each of the modules 450 can include one or more gas infusion modules, such as gas infusion module 100, at or near the inlet 452a, 452b. For example, a first gas infusion module 460a can be positioned at or near the first inlet 352a and a second gas infusion module 360b can be positioned at or near the inlet 452b. The gas injected into the system 300 via the inlets 452a, 452b of the modules 450 can be infused into the fibers of the gas infusion modules 460a, 460b. For example, after entering the modules 450, the gas can flow through the modules 450 and the fibers of the gas infusion modules 460a, 460b and infuse the liquid flowing through the module 450 (e.g., between the first plurality of distribution lines 330 and the second plurality of distribution lines 340).

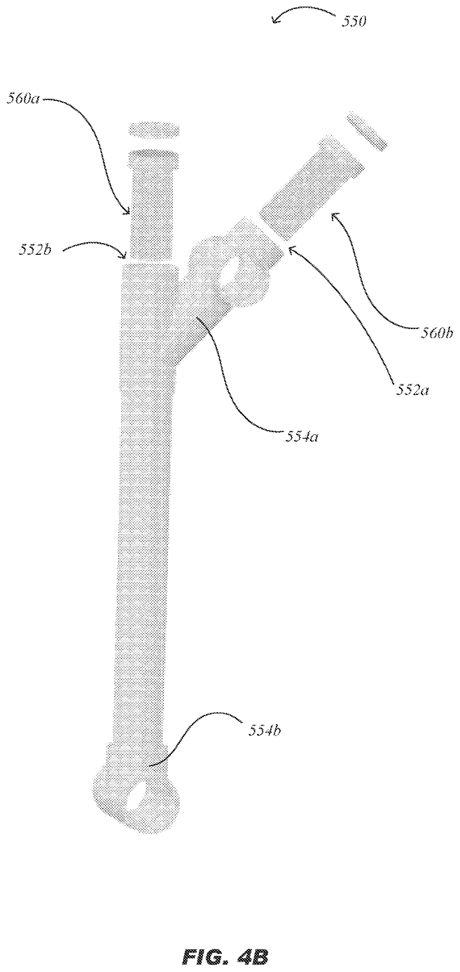

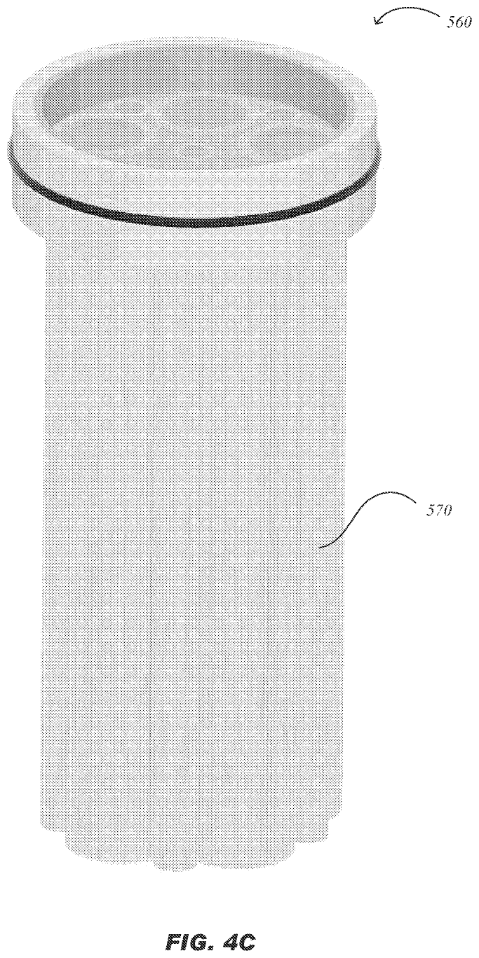

FIG. 4A shows another example of a module 550 which can be used in gas infusion module system 300. Each of the modules 550 can include one or more inlets 552a, 552b, which can be in fluid connection with a source of gas (e.g., oxygen). The modules 550 can also include an upper adapter 554a and a lower adapter 554b. The inlet 552a is at an angle relative to the inlet 552b and disposed higher than the inlet 552b, with the adapter 554a between the inlets 552a, 552b. The upper and lower adapters 554a, 554b can facilitate attachment of the modules 550 to each other and/or to the first and second plurality of distribution lines 330, 340 of the system 300. For example, the upper adapter 554a of a first module 550 can be connected to the first plurality of distribution lines 330 on one end and to a second upper adapter 554a of a second module 550 on the other end. The upper adapter 554a can also be connected to a pair of upper adapters 554a (e.g., of adjacent modules 550) on both ends. The connection between the upper adapters 554a and the first plurality of distribution lines 330 can allow the liquid entering the system 300 via the inlet 312 to flow though the modules 550. The lower adapter 554b of a first module 550 can be connected to the second plurality of distribution lines 340 on one end and to a second lower adapter 554b of a second module 550 on the other end. The lower adapter 554b can also be connected to a pair of lower adapters 554b (e.g., of adjacent modules 550) on both ends. The connection between the lower adapters 554b and the second plurality of distribution lines 340 can allow the liquid flowing entering the system 300 to flow through the modules 550 and the second plurality of distribution lines 340, and exit the system 300 via the outlet 322 of the second pipe 320.

FIG. 4B shows an exploded view of a module 550. Each of the modules 550 can include one or more gas infusion modules, such as gas infusion module 100, at or near the inlet 552a, 552b. For example, a first gas infusion module 560a can be positioned at or near the first inlet 552a and a second gas infusion module 560b can be positioned at or near the inlet 552a. The gas injected into the system 300 via the inlets 552a, 552b of the modules 550 can be infused into the fibers of the gas infusion modules 560a, 560b. For example, after entering the modules 550, the gas can flow through the modules 550 and the fibers of the gas infusion modules 560a, 560b. As shown in FIG. 4C, a gas infusion module 560 can include a plurality of fibers 570. The plurality of fibers 570 can be infused with a gas as described above and infuse the liquid flowing through the module 550 (e.g., between the first plurality of distribution lines 330 and the second plurality of distribution lines 340).

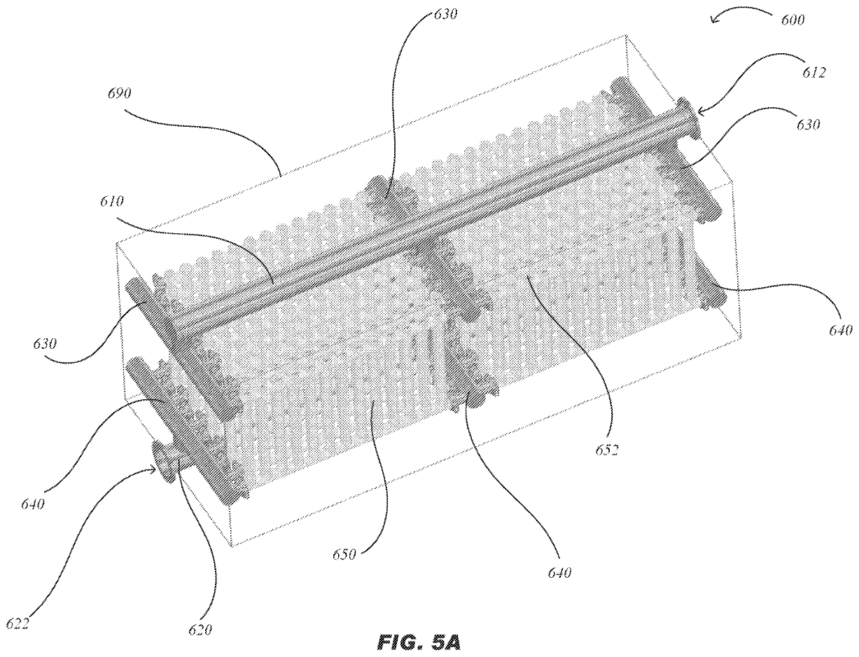

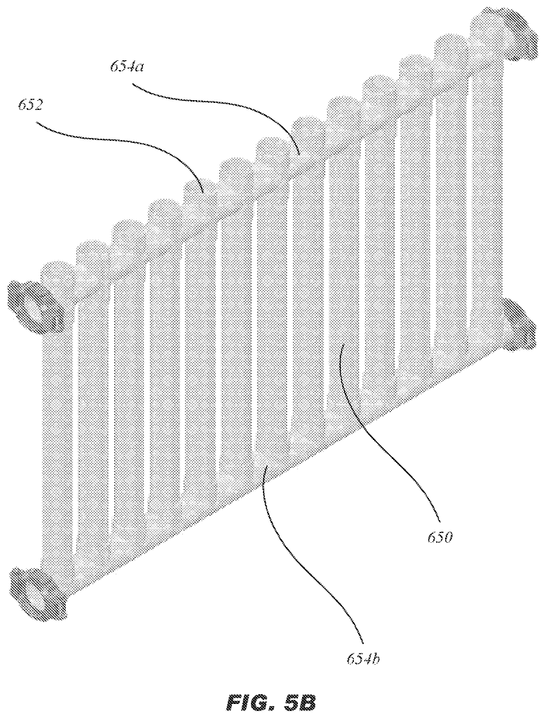

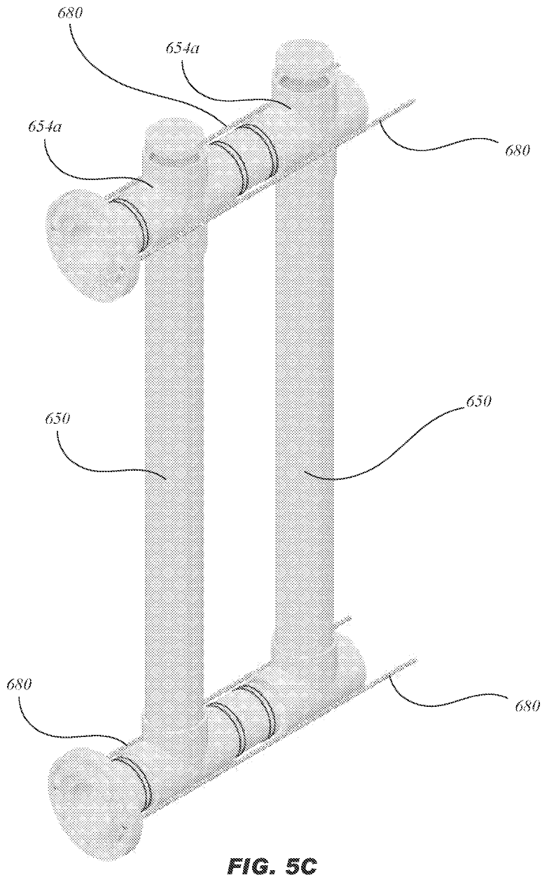

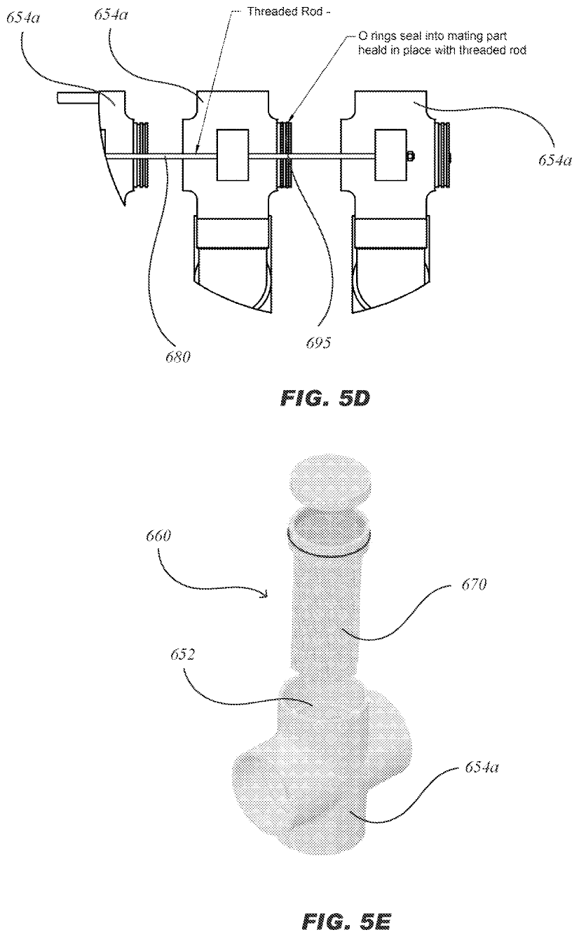

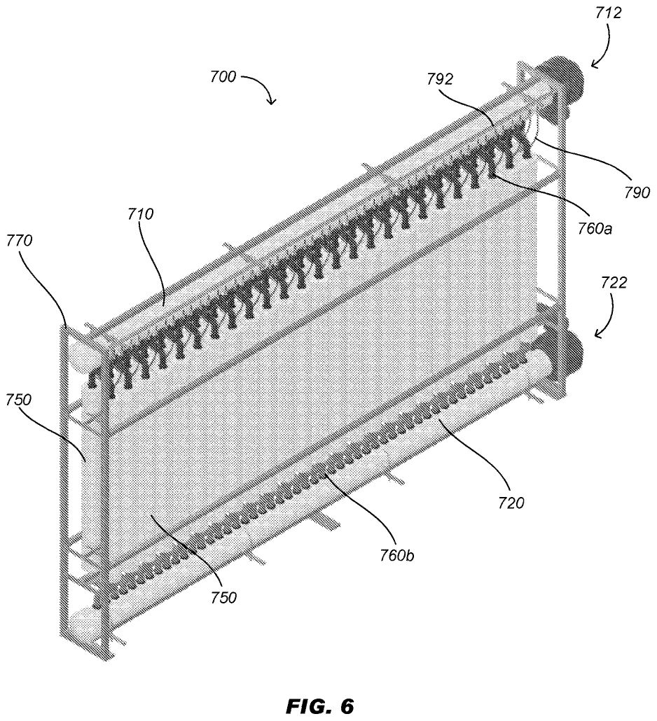

FIG. 5A shows another embodiment of a gas infusion module system 600. The gas infusion module system 600 can include a first pipe 610, a second pipe 620, a first plurality of distribution lines 630, a second plurality of distribution lines 640, and one or more modules 650. The gas infusion module system 600 can be arranged inside a container 690. The gas infusion module system 600 can be in fluid connection with a source of liquid. For example, liquid can enter the gas infusion module system 600 via an inlet 612 of the first pipe 610. The fluid can flow through the system 600 via the first pipe 610, the first plurality of distribution lines 630, the modules 650, the second plurality of distribution lines 640, and exit the system via an outlet 622 of the second pipe 620. The first plurality of distribution lines 630 can be in fluid communication with the first pipe 610 via one or more adapters, and the second plurality of distribution lines 640 can be in fluid communication with the second pipe 620 via one or more adapters.

FIGS. 5B-5C shows an example of an array of modules 650 (e.g., linear array, arranged in parallel) which can be used in gas infusion module system 600, or any of the gas infusion module systems disclosed herein, and FIGS. 5D-5E show features of the module 650. Each of the modules 650 can include at least one inlet 652 which can be in fluid connection with a source of gas (e.g., oxygen). The modules 650 can also include an upper adapter 654a and a lower adapter 654b. In some cases, the upper adapter 654a includes a continuous body having a plurality of openings for securing the one or more modules 650. The lower adapter 654b can include a continuous body having a plurality of openings for securing the one or more modules 650. The upper and lower adapters 654a, 654b can facilitate attachment of the modules 650 to each other and/or to the first and second plurality of distribution lines 630, 640 of the system 600. In some cases, system 600 can include an adjustable threaded rod 680 removably attached to each module 650. The rod 680 can be attached to, for example, the upper adapters 654a and/or the lower adapters 654b. The rod 680 can be turned clockwise and/or anticlockwise to separate and/or bring the modules 650 closer to each other. One or more O-rings 695 can be placed between each pair of upper adapters 654a and/or each pair of lower adapters 654b to provide a seal between each pair of upper and lower adapters 654a, 654b, as shown in FIG. 5D. In some cases, the upper adapter 654a of a first module 650 can be connected to the first plurality of distribution lines 630 on one end and to a second upper adapter 654a of a second module 650 on the other end. The upper adapter 654a can also be connected to a pair of upper adapters 654a (e.g., of adjacent modules 650) on both ends. The connection between the upper adapters 654a and the first plurality of distribution lines 630 can allow the liquid entering the system 600 via the inlet 612 to flow though the modules 650. The lower adapter 654b of a first module 650 can be connected to the second plurality of distribution lines 640 on one end and to a second lower adapter 654b of a second module 650 on the other end. The lower adapter 654b can also be connected to a pair of lower adapters 654b (e.g., of adjacent modules 650) on both ends. The connection between the lower adapters 654b and the second plurality of distribution lines 640 can allow the liquid flowing entering the system 600 to flow through the modules 650 and the second plurality of distribution lines 640, and exit the system 600 via the outlet 622 of the second pipe 620.

Each of the modules 650 can include one or more gas infusion modules, such as gas infusion module 100, at or near the inlet 652. For example, a gas infusion module 660 can be positioned at or near the inlet 652, as shown in FIGS. 5C and 5E. The gas injected into the system 600 via the inlet 652 of the modules 650 can be infused into the fibers of the gas infusion module 660. For example, after entering the modules 650, the gas can flow through the modules 650 and the fibers of the gas infusion module 660. The gas infusion module 660 can include a plurality of fibers 670. The plurality of fibers 670 can be infused with a gas as described above and infuse the liquid flowing through the module 650 (e.g., between the first plurality of distribution lines 330 and the second plurality of distribution lines 340).

FIG. 6 shows another embodiment of a gas infusion module system 700. The gas infusion module system 700 can include a first pipe 710 (e.g., header), a second pipe 720 (e.g., footer), and one or more modules 750. The gas infusion module system 700 can be secured to a frame 770. Each of the modules 750 can be in fluid communication with a source of gas (e.g., oxygen). For example, each module 750 can be in fluid connection with gas tubing 790. The gas tubing 790 can be in fluid connection with a gas delivery line 792 which can be connected to a source of gas (e.g., a source of oxygen). Each of the modules 750 can be fluidly connected to the first pipe 710 via a plurality of connectors 760a (e.g., connecting pipes). In some cases, each of the connectors 760a may be connected to the first pipe 710 and/or one or more modules 750. For instance, each connector 760a can be fluidly connected to two modules 750. Each of the modules 750 can be fluidly connected to the second pipe 720 via a plurality of connectors 760b (e.g., connecting pipes). In some cases, each of the connectors 760b may be connected to the second pipe 720 and/or one or more modules 750. For instance, each connector 760b can be fluidly connected to two modules 750. The gas infusion module system 700 can be in fluid connection with a source of liquid. For example, liquid can enter the gas infusion module system 700 via an inlet 712 of the first pipe 710. The fluid can flow through the system 700 via the first pipe 710, the connectors 760a, the modules 750, the connectors 760b, and exit the system via an outlet 722 of the second pipe 720. The inlet 712 and the outlet 722 can be on the same side of the gas infusion module system 700, as shown in FIG. 6, or in another implementation can be positioned on different sides of the gas infusion module system 700.

The gas infusion module system 700 can include at least fifty modules 750 arranged in two rows of twenty-five modules 750 each. In some cases, the gas infusion module system 700 can include more than or less than fifty modules 750 (e.g., 10, 20, 30, 40, 60, 70, 80, 90, etc. modules). Although reference is made to the modules 750 being arranged in a two-row configuration, the modules 750 can be arranged in different configurations (1, 2, 3, 4, 5, etc., rows).

Each of the modules 750 can include one or more gas infusion modules, such as gas infusion module 100, 350a or 560a described above. For example, a gas infusion module 100, 350a, 560a can be positioned inside each of the modules 750. The gas injected into the system 700 via the fluid connections between the modules 750 a source of gas can be infused into the fibers of the gas infusion modules 100, 350a, 560a. For example, after entering the modules 750, the gas can flow through the modules 750 and the fibers of the gas infusion modules 100, 350a, 560a and infuse the liquid flowing through each module 750 (e.g., between the connectors 760a and the connectors 760b).

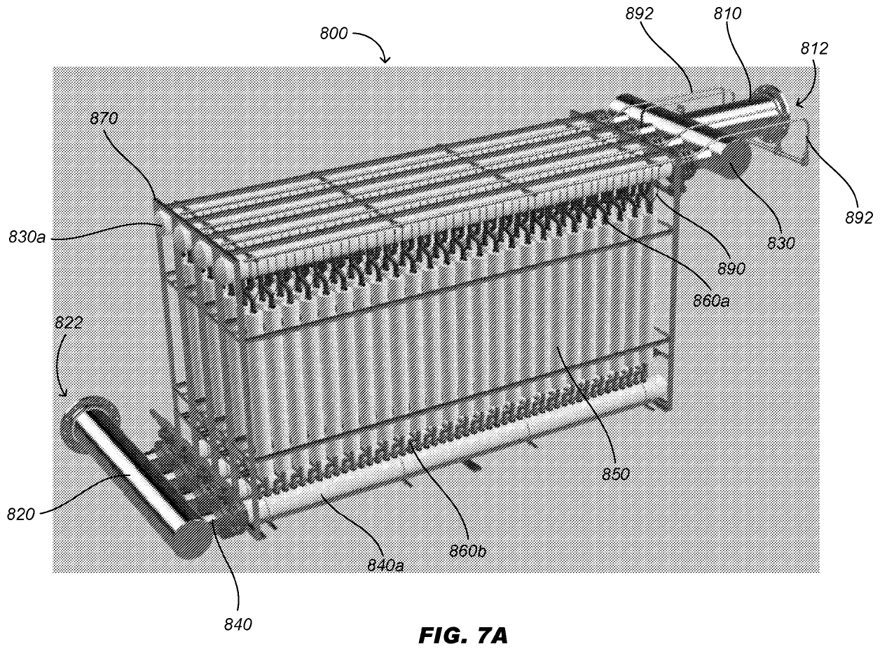

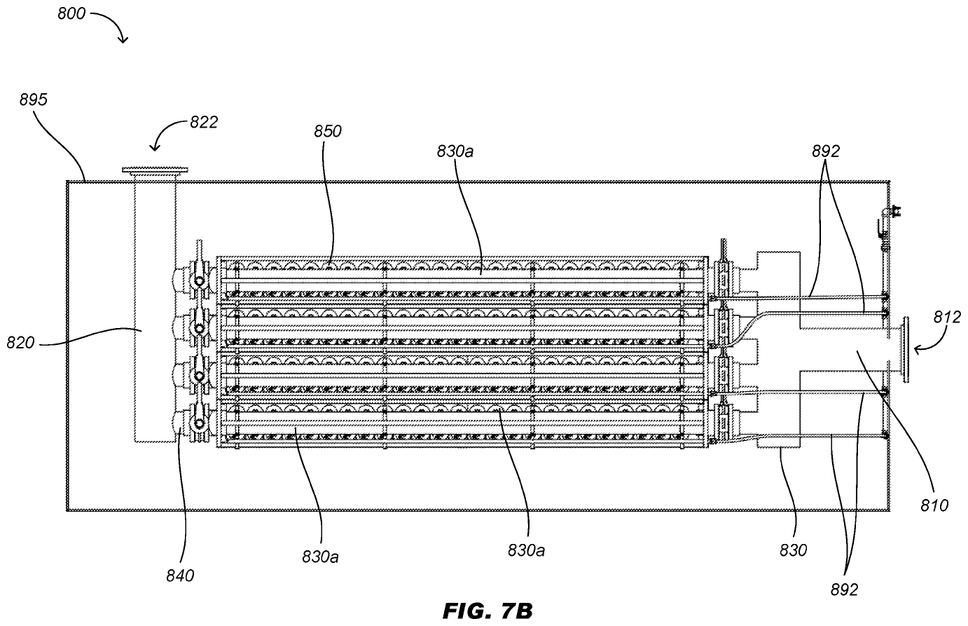

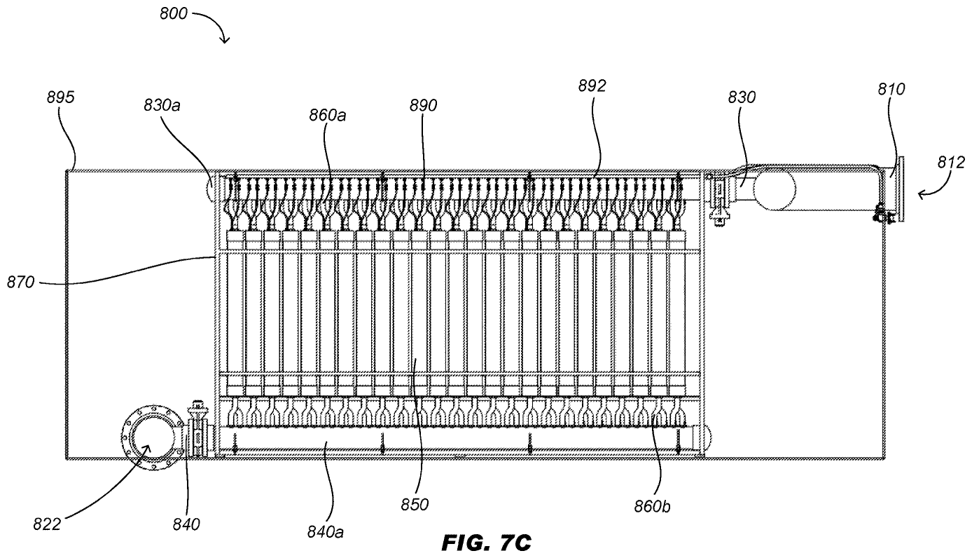

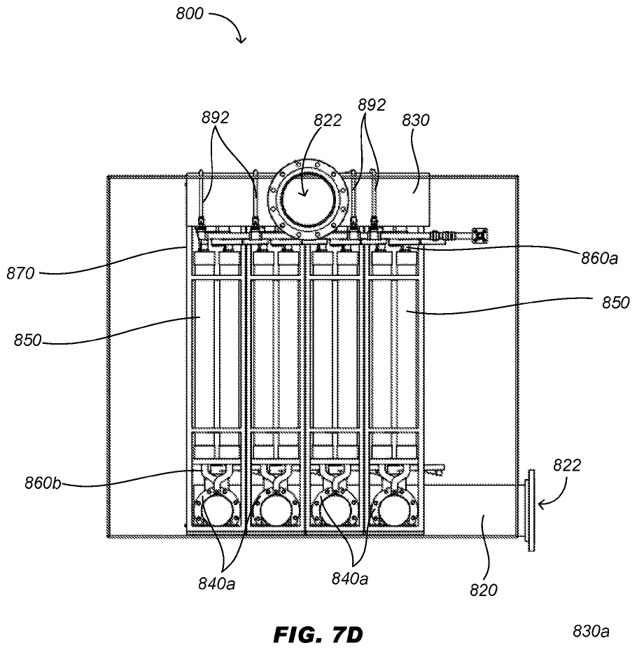

FIGS. 7A-7D show another embodiment of a gas infusion module system 800. The gas infusion module system 800 can include a first pipe 810, a second pipe 820, first distribution line 830, a second distribution line 840, and one or more modules 850. The first pipe 810 can be in fluid communication with the first distribution line 830, and the second pipe 820 can be in fluid communication with the second distribution line 840. The first distribution line 830 can be connected to one or more pipes 830a (e.g., headers) in fluid communication with the modules 850 via one or more connections 860a (e.g., connecting pipes). The second distribution line 840 can be connected to one or more pipes 840a (e.g., footers) in fluid communication with the modules 850 via one or more connections 860b (e.g., connecting pipes). In some cases, the gas infusion module system 800 can include four pipes 830a (e.g., four headers) and four pipes 840a (e.g., four footers). The gas infusion module system 800 can include more than or less than four pipes 830 a and four pipes 840 a (e.g., 1 of each, 2 of each, 3 of each, 5 of each, 6 of each, etc.). In some cases, the number of pipes 830 a and the number of pipes 840a may be different.

The gas infusion module system 800 can be arranged inside a container 895, as shown in FIGS. 7B-7D. In some cases, the container 895 measures about 96 in (in width and height) by about 240 in (in length). The container 895 can include one or more openings through which the first and second pipes 810, 820 can at least partially extend. The gas infusion module system 800 can be secured to a frame 870.

Each of the modules 850 can be in fluid communication with a source of gas (e.g., oxygen). For example, each module 850 can be in fluid connection with gas tubing 890. The gas tubing 890 can be in fluid connection with one or more gas delivery lines 892 which can be connected to a source of gas. Each of the modules 850 can be fluidly connected to the one or more pipes 830a via the plurality of connectors 860a. In some cases, each of the connectors 860a may be connected to one of the pipes 830a and/or one or more modules 850. For instance, each connector 860a can be fluidly connected to two modules 850. Each of the modules 850 can be fluidly connected to the one or more pipes 840a via the plurality of connectors 860b. In some cases, each of the connectors 860b may be connected to one of the pipes 840a and/or one or more modules 850. For instance, each connector 860b can be fluidly connected to two modules 850.

The gas infusion module system 800 can be in fluid connection with a source of liquid. For example, liquid can enter the gas infusion module system 800 via an inlet 812 of the first pipe 810. The fluid can flow through the system 800 via the first pipe 810, the first distribution line 830, the pipes 810, the connectors 860a, the modules 850, the connectors 860b, the second distribution line 840, and exit the system via an outlet 822 of the second pipe 820.

The gas infusion module system 800 can include at least two-hundred modules 850 arranged in eight rows of twenty-five modules 850 each. In some cases, the gas infusion module system 800 can include more than or less than two-hundred modules 750 (e.g., 100, 120, 140,160, 180, 220, 240, 260, etc. modules). Although reference is made to the modules 850 being arranged in an eight-row configuration, the modules 850 can be arranged in different configurations (2, 4, 6, 8, etc., rows).

Each of the modules 850 can include one or more gas infusion modules, such as gas infusion module 100. For example, a gas infusion module 100 can be positioned inside each of the modules 850. The gas injected into the system 800 via the fluid connections between the modules 850 a source of gas can be infused into the fibers of the gas infusion modules 100. For example, after entering the modules 850, the gas can flow through the modules 850 and the fibers of the gas infusion modules 100 and infuse the liquid flowing through each module 850 (e.g., between the connectors 860a and the connectors 860b).

Any of the modules disclosed herein, including modules 350, 450, 550, 650, 750, and 850, and/or the gas infusion modules positioned inside the modules (e.g., gas infusion module 100) can each be individually replaced. Using the gas infusion module system 800 as an example, each module 850 and the gas infusion module 100 positioned inside the module 850 can be removed from the system 800. The module 850 can be replaced with a new module 850 and/or a new gas infusion module 100. Each module 850 can be removed from the system 800 by disconnecting the module 850 from the connectors 860a and the connectors 860b. In some cases, a gas infusion module 100 can be replaced with a new gas infusion module 100. The new gas infusion module 100 can be positioned inside the removed module 850. Once the new gas infusion module is positioned inside the module 850, the module 850 can be reattached to the system 800.

To prevent the liquid flowing through the system 800 from spilling when a module 850 and/or gas infusion module 100 is being replaced, flow through the system 800 can be restricted (e.g., prevented, shut-off). For example, flow along the first pipe 810, the first distribution line 830, and/or the one or more pipes 830 can be restricted using one or more valves (not shown). In some cases, flow can be restricted (e.g., prevented, shut-off) in only a subset of the one or more pipes 830a. For instance, each of the one or more pipes 830a and/or the first distribution line 830 can include more than one valve for selectively restricting(e.g., preventing, shutting-off) flow through the one or more pipes 830a. This can beneficially allow for the replacement of a module 850 and/or a gas infusion module 100 without interrupting flow (e.g., fluid treatment) in the entire system 800.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

1. A gas infusion module system comprising:
a first pipe having an inlet for receiving a fluid from a source of fluid;
an array of modules positioned downstream of and in fluid communication with the first pipe, the array of modules comprising:
an inlet in fluid connection with a source of gas; and
a gas infusion module comprising a plurality of fibers, the gas infusion module disposed at least partially inside the array of modules;
a second pipe having an outlet, the second pipe positioned downstream of and in fluid communication with the array of modules;
wherein the fluid flows through the array of modules and exits the system via the outlet.

2. The gas infusion module system of claim 1, further comprising:
a first plurality of distribution lines in fluid connection with the first pipe and the array of modules; and
a second plurality of distribution lines in fluid connection with the second pipe and the array of modules.

3. The gas infusion module system of claim 1, wherein the gas inlet comprises a first gas inlet and a second gas inlet, and wherein the gas infusion module comprises a first gas infusion module positioned at the first gas inlet and a second gas infusion module positioned at the second gas inlet.

4. The gas infusion module system of claim 1, wherein the array of modules includes 120 modules.

5. (canceled)

6. The gas infusion module system of claim 1, wherein the array of modules includes 260 modules.

7. (canceled)

8. The gas infusion module system of claim 1, wherein the array of modules further comprise a first adapter and a second adapter, the first and second adapters configured to secure a first module of the array of modules to at least a second module of the array of modules.

9. The gas infusion module system of claim 8, wherein the first adapter is positioned on a first end of the array of modules and the second adapter is positioned on a second end of the array of modules.

10. The gas infusion module system of claim 8, further comprising:
at least one rod removably attached to at least one of the first and second adapters; and
at least one O-ring positioned between at least one of a pair of first adapters and a pair of second adapters;
wherein the rod is configured to adjust a distance between the at least the one pair of first adapters and the pair of second adapters; and
wherein the at least one O-ring creates a seal between the at least the one pair of first adapters and the pair of second adapters.

11. A gas infusion module system comprising:
a first pipe having an inlet for receiving a fluid from a source of fluid;
an array of modules positioned downstream of and in fluid communication with the first pipe, the array of modules comprising:
a gas infusion module comprising a plurality of fibers, the gas infusion module disposed at least partially inside the array of modules;
a second pipe having an outlet, the second pipe positioned downstream of and in fluid communication with the array of modules;
wherein the array of modules is in fluid communication with a source of gas via a gas tubing;
wherein the fluid flows through the array of modules and exits the system via the outlet.

12. The gas infusion module system of claim 1, further comprising a first plurality of connectors, each connector of the first plurality of connectors in fluid communication with the first pipe and at least two modules of the array of modules.

13. The gas infusion module system of claim 11, further comprising a second plurality of connectors, each connector of the second plurality of connectors in fluid communication with the second pipe and at least two modules of the array of modules.

14. The gas infusion module system of claim 11, wherein the inlet and the outlet are positioned on a first side of the of the gas infusion module system.

15. The gas infusion module system of claim 11, wherein the array of modules includes 50 modules.

16. The gas infusion module system of claim 11, wherein the array of modules is arranged in a twenty-five-by-two array.

17. A gas infusion module system comprising:
a first pipe having an inlet for receiving a fluid from a source of fluid;
a first distribution line positioned downstream of and in fluid communication with the first pipe;
a plurality of headers positioned downstream of and in fluid communication with the first distribution line;
an array of modules positioned downstream of and in fluid communication with the plurality of headers, the array of modules comprising a gas infusion module comprising a plurality of fibers, the gas infusion module disposed at least partially inside the array of modules;
a plurality of footers positioned downstream of and in fluid communication with the array of modules;
a second distribution line positioned downstream of and in fluid communication with the first pipe;
a second pipe having an outlet, the second pipe positioned downstream of and in fluid communication with the second distribution line;
wherein the array of modules is in fluid communication with a source of gas;
wherein the fluid flows through the array of modules and exits the system via the outlet.

18. The gas infusion module system of claim 17, further comprising a first plurality of connectors, each connector of the first plurality of connectors in fluid communication with the plurality of headers and at least two modules of the array of modules.

19. The gas infusion module system of claim 17, further comprising a second plurality of connectors, each connector of the second plurality of connectors in fluid communication with the plurality of footers and at least two modules of the array of modules.

20. The gas infusion module system of claim 17, wherein the inlet and the outlet are positioned on opposite sides of the gas infusion module system.

21. The gas infusion module system of claim 17, wherein the array of modules includes 250 modules.

22. The gas infusion module system of claim 17, wherein the array of modules is arranged in a twenty-five-by-eight array.

23. (canceled)

24. (canceled)
